(19) United States
(12) Patent Application Publication
(10) Pub. No.: US 2015/0115004 A1
(43) Pub. Date: Apr. 30, 2015

(54) DRY ERASE BRACELET

(71) Applicants: Colleen FINNEGAN, Brick, NJ (US); Katelyn RILEY, Brooklyn, NY (US)

(72) Inventors: Colleen FINNEGAN, Brick, NJ (US); Katelyn RILEY, Brooklyn, NY (US)

(21) Appl. No.: 14/521,192

(22) Filed: Oct. 22, 2014

Related U.S. Application Data
(60) Provisional application No. 61/897,004, filed on Oct. 29, 2013.

(51) Int. Cl. B43K 23/00; A45F 5/00

(52) U.S. Cl. CPC B43K 23/00; A45F 5/00; A45F 2005/008
USPC 224/219; 72/379.2; 264/239

(57) ABSTRACT

A bracelet may be configured with a main body and sized to fit around the wrist of a person with the outer surface area configured and/or prepped as a writeable surface to allow and encourage doodles, notes, artwork, etc. These notes and doodles may be erasable via e.g., a special “eraser” marker. The outer surface and inner surface of the bracelet may be curved to match a general shape, and sized to fit, a human wrist, ankle, leg or arm. The markers held in holsters formed at the proximal and distal ends of the bracelet which may be curled inwardly to hold markers by way of friction fit.

### CROSS-REFERENCE TO RELATED APPLICATIONS

This application claims benefit and priority to U.S. Provisional Application No. 61/897,004 filed Oct. 29, 2013, the disclosure of which is incorporated by reference herein in its entirety.

### BACKGROUND

1.0 Field of the Disclosure

The disclosure is generally directed to a bracelet, and more particularly, a bracelet that is configured with a writeable and erasable surface, among other features.

2.0 Related Art

Bracelets are available today, but are typically fashion-related only. The bracelets rarely provide other functional features. Many people, both women and men, young and old, often find themselves in a situation where a piece of information should be retained such as, e.g., a telephone number, a name, an address or other information, and there is no convenient way to write it down.

A solution that combines convenience of recording information and the use of a fashion article like a bracelet would provide such a convenience.

### SUMMARY OF THE INVENTION

In one aspect, a bracelet is provided that includes a main body configured with a curved writeable outer surface and a curved inner surface, a pair of spaced apart descending portions descending from the main body, wherein the descending portions narrow in width, a pair of spaced-part curls formed on a lower end of the descending portions, wherein a width of each curl is less than the width of the main body, and wherein each curl is configured to accept and hold a marker pen therewithin. The writeable outer surface may comprise a coating of material suitable for receiving and maintaining ink wherein the coating permits easy erasing of the ink. The curved inner surface may comprise a coating of material suitable for receiving and maintaining ink wherein the coating permits easy erasing of the ink. Each curl may curl back toward the respective descending portion. Each curl may be configured to be spaced-apart from one another so that the centers of each curl are configured to be at a distance selected from a range ranging from about 1.2″ to about 1.7″. The distance may be about 1.9″. The bracelet may be configured so that the curved outer surface becomes an inner surface of each curl. The bracelet may be configured so that the curved inner surface becomes an outer surface of each curl. The bracelet may further include at least one marker for producing erasable ink on at least one of the surfaces and configured to be insertable and removable within at least one curl and held therein by friction fit.

In one aspect, a bracelet is provided that includes a main body configured with a curved writeable outer surface and a curved inner surface, a pair of spaced apart descending portions descending from the main body, wherein the descending portions narrow in width, a pair of spaced-part curls formed from a lower end of the descending portions, wherein a width of an outer surface of each curl is less than the width of the main body, and a distance from an outermost surface of one curl to an outermost surface of the other curl is less than the maximum overall width of the main body, wherein each curl is configured to accept and hold a dry-erase marker pen therewithin. The writeable outer surface may comprise a coating of material suitable for receiving and maintaining ink wherein the coating permits easy erasing of the ink. The curved inner surface may comprise a coating of material suitable for receiving and maintaining ink wherein the coating permits easy erasing of the ink. Each curl may curl back toward the respective descending portion and is one of: open and closed, with the descending portion. Each curl may be configured to be spaced-apart from one another so that the centers of each curl are configured to be at a distance selected from a range ranging from about 1.2″ to about 1.7″. The bracelet may be configured so that the curved outer surface becomes an inner surface of each curl and the curved inner surface becomes an outer surface of each curl.

In one aspect, a method for making a dry erase bracelet is provided that includes the steps of providing a main body configured with a curved writeable outer surface and a curved inner surface, configuring a pair of spaced apart descending portions descending from the main body, wherein the descending portions narrow in width, forming a pair of spaced-part curls formed on a lower end of the descending portions, wherein a width of each curl is less than the width of the main body, and wherein each curl is configured to accept and hold a marker pen therewithin. The method may further comprise the step of providing a dry erasable ink marker configured to be held in at least one curl by friction fit.

### BRIEF DESCRIPTION OF THE DRAWINGS

FIG. 1 is a front view of a dry erase bracelet having a writeable and erasable outer surface;

FIG. 2 is a top plan view of FIG. 1;

FIG. 3 is a side elevation view of FIG. 1;

FIG. 4 is a bottom plan view of FIG. 1;

FIG. 5 is a front elevation perspective view of FIG. 1;

FIG. 6 is a bottom perspective view of FIG. 1;

FIG. 7 is a front elevation perspective view of FIG. 1 showing storage of optional dry-erase pens;

FIG. 8 is a bottom perspective view of FIG. 8 showing storage of optional dry-erase pens;

FIG. 9 is an illustration of an example dry erase pen usable with the dry erase bracelet of FIG. 1, configured according to principles of the disclosure; and

FIG. 10 is an illustration showing exemplary dimensions of the bracelet of FIG. 1.

### DETAILED DESCRIPTION OF THE DISCLOSURE

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings. The term “about” means within +/−10%, unless context states otherwise.

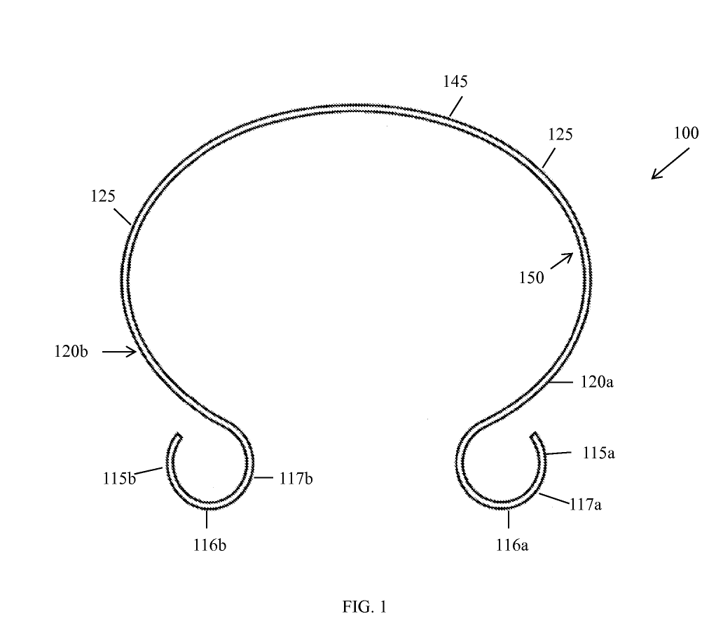

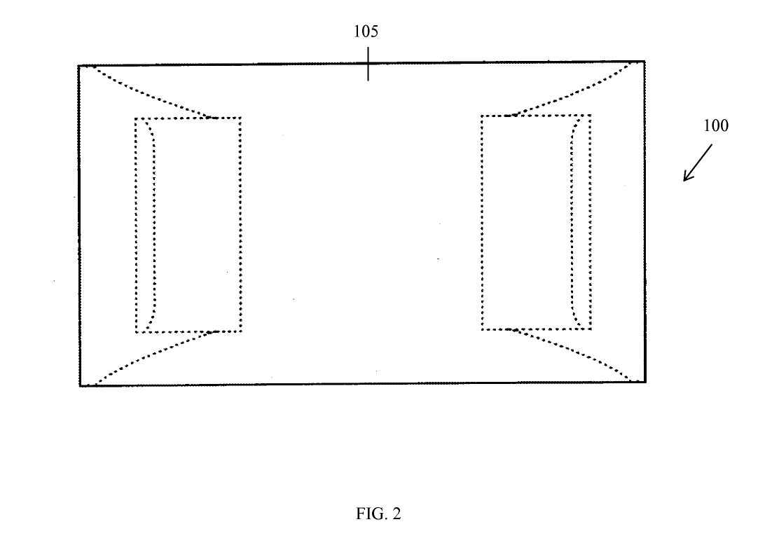

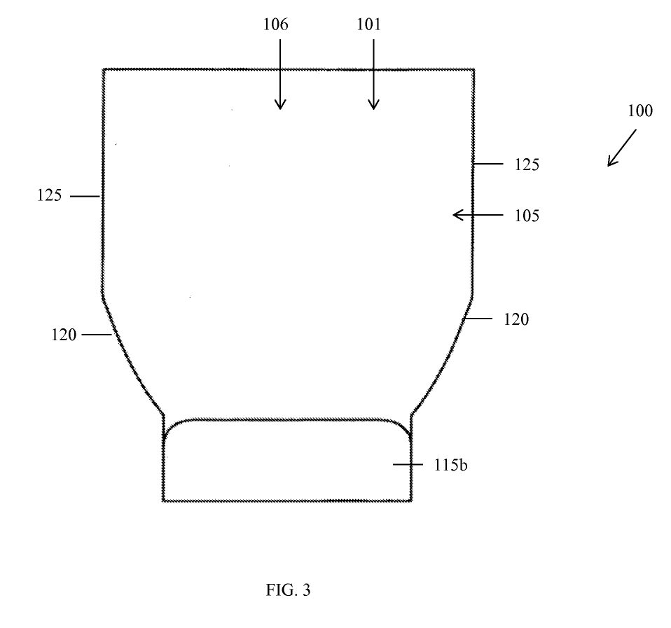

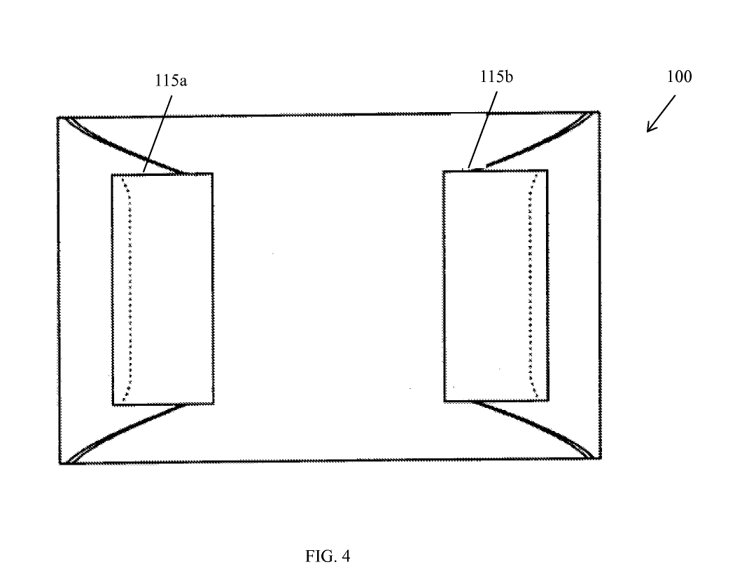

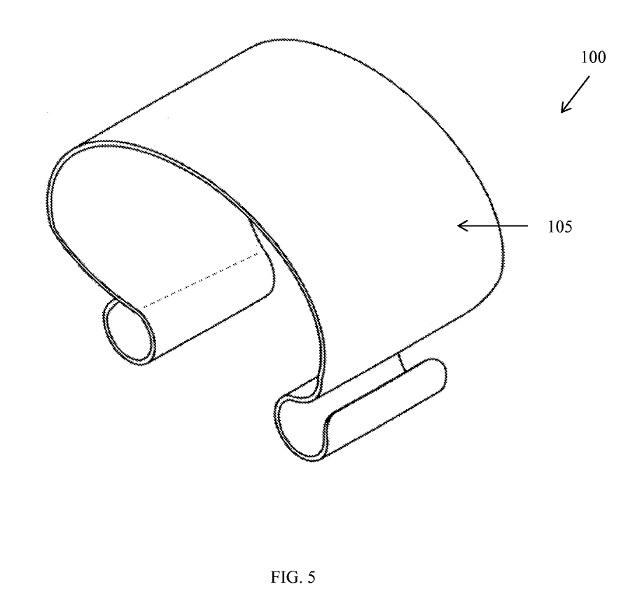

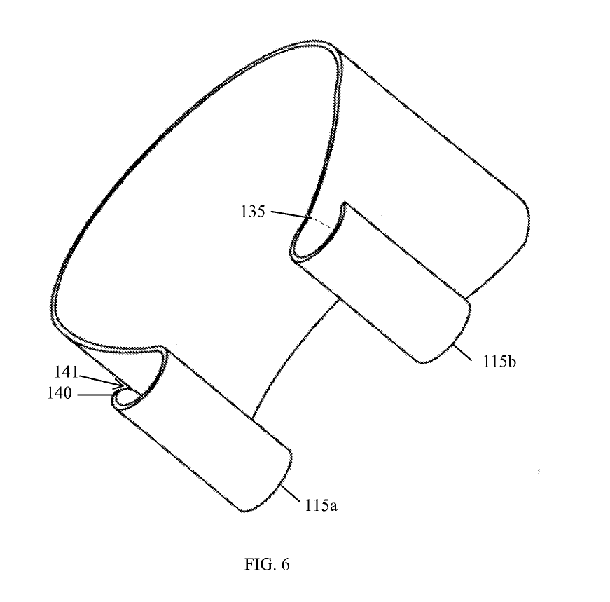

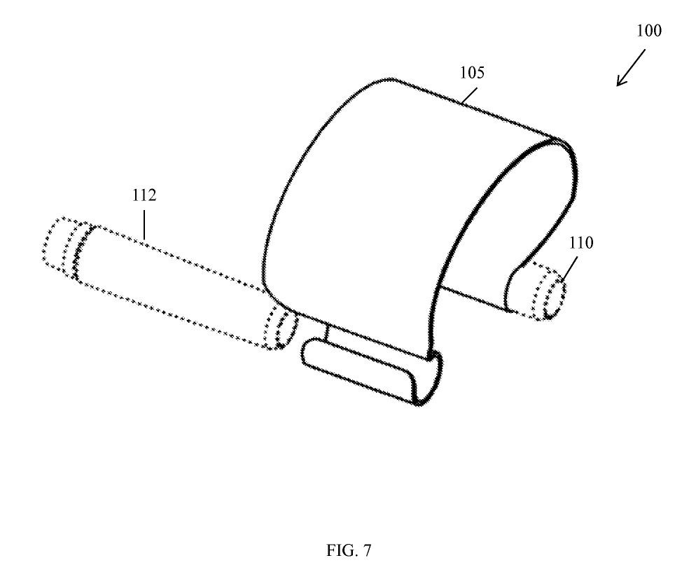

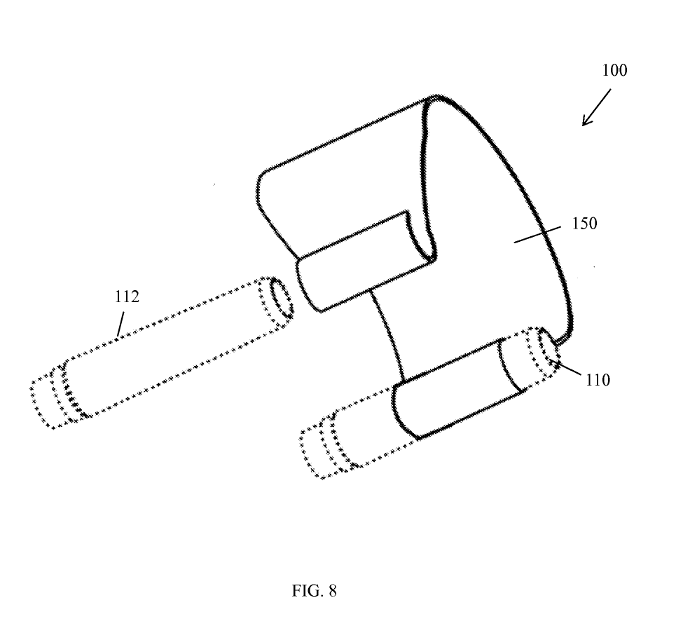

Bracelets may be known in the fashion industry as a “cuff” often due to its large surface area. FIG. 1 is a front view of a bracelet configured according to principles of the disclosure; FIG. 2 is a top view of FIG. 1, FIG. 3 is a side view of FIG. 1, FIG. 4 is a bottom view of FIG. 1, FIG. 5 is a front perspective view of FIG. 1, FIG. 6 is a bottom perspective view of FIG. 1, FIG. 7 is a side elevation perspective view showing optional markers 110, 112 of a bracelet of FIG. 1, FIG. 8 is a bottom perspective view of FIG. 1 showing optional markers 110, 112. The bracelet 100 may be configured with a main body 101, the bracelet 100 sized to fit around the wrist of a person with the outer surface area 105 configured and/or prepped as a writeable surface 106 to allow and encourage doodles, notes, artwork, etc. These notes and doodles may be erasable via, e.g., a special “eraser” marker, described more below. The outer surface 105 and inner surface 150 may be curved 145 to match a general shape, and sized to fit a human wrist, ankle, leg or arm.

Markers 110, 112 may be held in holsters 115a, 115b at the proximal and distal ends of the bracelet 100 which may be curled inwardly to hold markers 110 by way of friction fit. The curls 115a, 115b may be configured in an open manner as shown, or curls 115a, 115b may be configured to be closed against the inwardly descending portion 120a, 120b of the bracelet. An outwardly descending portion 125 of the bracelet changes direction to the inwardly descending portion 120a, 120b of the bracelet 100. The width of the inwardly descending portion 120a, 120b also narrows between the outwardly descending portion 125 and the curls 115a, 115b. The curls 115a, 115b may be narrower in width as compared to the outwardly descending portion 125, as shown in FIG. 3. The inwardly descending portion 120a, 120b of the bracelet may narrow in width from the outwardly descending portion 125 of the bracelet to the holsters 115a, 115b, as shown in FIG. 3. The holsters 115a, 115b may curl outwardly and then curl inwardly, as shown in FIG. 1. The outer surface 105 may become an inner surface 116a, 116b of the curls 115a, 115b. The inner surface 150 (opposite the outer surface 105) may become the outer surface 117a, 117b of the curls 115a, 115b.

The outer surface 105 may be writeable and erasable at least in part, or may stop proximate the junction 135 (FIG. 6) with each of the curls 115a, 115b. Alternatively, the entire outer surface 105 and the entire inner surface 150 may be writeable and erasable and coated like surface 105 with coating 106. The holsters 115a, 115b may be configured with a rounded edge 140, which may also be a part of an inwardly curving lip 141 of each curl 115a, 115b. The coating 106 may comprise sheer, white, black or colored dry-erase paint. The coating may comprise a water-based dry erase paints such as manufactured, e.g., by Rust-o-leum™. The coating may comprise a latex-based paint formula. The coating may comprise non-porous plastic. Alternatively, the coating 106 may comprise a layer providing a dry-erasable surface such as, e.g., melamine surface, a Plexiglas strip, a Lexan strip, a polymer material, a tile board strip. The layer may be affixed or attached by a securing technique such as by adhesive, clasping mechanism, magnetic mechanism, or a similar attaching technique. Painted coatings may include one or more of the following, in any effective combination: Titanium Dioxide, Aluminium oxide, Silicon dioxide, Siloxanes and silicones, di-me, methoxy ph polymers with ph silsesquioxanes, methoxy-terminated, Epoxy resin, Propylene carbonate Bis, sebacate Dibutyltin di(acetate), Silicon dioxide, Ethanol, Ethylbenzene, Xylene, Wollastonite, and carbon black for coloring

This bracelet 100 may be worn by children and adults alike, allowing customers with a creative outlet that effortlessly travels with them during their day. Each bracelet 100 may optionally come with one colored marker 110 and one eraser marker 112 (FIG. 7). Additional markers may be sold separately. Premium packages may also be sold to include additional colors or products. In some versions, the markers 110, 112 may comprise a dry-erase marker and/or an erasable crayon.

The bracelet 100 may comprise a flexible metal, e.g., copper 110 alloy springs temper, but other metals may be employed, e.g., stainless steels, nickel silver, or the like. Plastic or fabrics may be included in the construction of the bracelet 100, in whole or in part. The bracelet 100 may be stamped and formed utilizing, e.g., a 22 gauge for thickness. This size may vary to offer different designs but 22 gauge may be preferred, but not limited to this. When flattened, the bracelet may be about 9 inches in length, but may vary. About an inch of each end at the holster 115 may be about ½ inch shorter in width than the rest of the bracelet 100 (which is an inch and a half in thickness) to form the holster. These dimensions can be altered to create different sizes but all dimensions allow for rounded edges for safety.

The bracelet 100 may be coated on all sides, or one side, or part of a side, with a non-toxic dry-erase coating 106 that can be applied in essentially any color. This coating 106 is safe for direct contact to the skin. In one aspect, the writeable area may completely cover the entire bracelet on all sides allowing for maximum “doodle” area on this product.

This writeable bracelet 100 may serve as a “doodle pad” anywhere the wearer goes. It may be worn on a wrist and is generally “one-size-fits-all.” Sizing is performed by the wearer through squeezing the sides of the bracelet 100 together, therefore shortening the gap between holsters around the wrist. The bracelet 100 may be tightened by the wearer to a level that is comfortable, allowing only slight movements up and down the wrist when the arm is in motion. The bracelet 100 may be removed by performing the opposite action, gently pulling the holsters 115a, 115b away from one another, enlarging the distance between edges and allowing the wrist to slip out.

The bracelet 100 may be worn correctly when the holsters 115a, 115b are on the underside of the wearer's forearm. The holsters 115a, 115b should rest comfortably under the wrist joint, about two thumb widths from where the pulse is taken on the wrist. This is to allow easy movement of the wrist during the wearing of the bracelet 100. The writeable surface is on the other side to allow easy writing while the palm of the hand is facing down. The bracelet should be tightened so the bracelet holsters do not slide up to the other side of the arm. The surface area for writing should always face up when the palm is face-down.

The holsters 115a, 115b (i.e., the section of the bracelet that holds the one or more markers 110, 112) of the bracelet compliment the marker, utilizing friction to keep the marker 110, 112 in place and scaled to the diameter of the marker(s) 110, 112. The “thinner” side of the marker (the writing end) may be inserted into the holster first. Then the wearer may push the marker in until the “thicker” side of the marker (the opposite side of the writing instrument) causes a friction that keeps the marker from sliding in any further, holding it securely in place.

To release and utilize the marker 110, 112, the wearer may push the “thinner” side of the marker 110, 112 back through the holster 115a, 115b with enough force to push through the friction that holds the thicker side in place, therefore allowing the marker to slide out of this holster.

The holster 115a, 115b may each include at least one rounded edge 140 of the bracelet 100 which may be cut to be a different width and formed with a radius. This edge 140 may be curled in to form a circle or near circle configuration, but may not be fully enclosed, but may be closed in some applications. There may be a small space between the edge of the curl and the rest of the bracelet 100. This may be due to a single stamping of this product and two forming processes (to form the bracelet and then the holster) to complete the shape of the product from a single cut of material. Additional processes may be involved should the bracelet be made from a cloth or soft goods material.

Diameter of the holster may vary to fit approved markers of different thickness in the holster. Only approved markers should be worn with this bracelet due to the safety of the wearer. Holster markers should not be resized by the wearer. The resizing of a holster may result in a malfunction of the product.

Holsters on the top and/or bottom of the bracelet cuff (i.e., facing the fingers and elbow of the bracelet) instead of on the sides. Bracelet may be made of other materials or metals (e.g., plastic, stainless steel, nickel silver, and/or silver, or in any combination).

In some versions, different coatings or coverings on the underside of the bracelet 100 may be employed to allow for branding and design. This may include a material (cloth or other) glued or attached to the underside of the bracelet that makes contact with the skin.

Alternate features include a dry erase necklace pendant partner product with a marker that may snap on the bracelet for complete closure instead of a push-to-tighten function, closing the gap between the two holsters 115a, 115b for extra security. This snap may occur on the inside of the bracelet. Markers may also have a special string attachment to the bracelet that connects the marker to the holster to keep the wearer from losing the approved marker during rigorous movement or activity.

Bracelets may also be configured with a smaller dry erase panel with leather or fabric closure. This may allow the bracelet to have fabric connectors and base rather than metal and to adjust the writeable surface to a more confined area to offer a combined look of a fabric and writeable bracelet. For example, the holsters and base of the bracelet may be fabric and the writeable area of the bracelet lies in varying sizes on the top side of the item. The “top side” is defined as the portion of the bracelet that faces “up” when the bracelet is worn correctly. Alternatively, bracelets 100 may also be completely covered in fabric to allow the fabric surface to be writeable and erasable, and/or to change the aesthetic appearance of the bracelet 100.

Alternate bracelet versions may also include chalkboard panel instead of dry erase panels and modified chalk pens instead of markers. The chalkboard panel may be configured to be only on the top of the bracelet and could be made in different colors allow for different aesthetics. Another version may include an eraser or marker attachable to the side of the bracelet. This may allow for the inclusion of an eraser mechanism to be attached on any side of the bracelet that could be detached and used for the quick removal of any design. This eraser can be a cloth or solid type eraser.

In different applications, thicker or thinner in cuff sizes may be utilized to allow for different sized looks to be created. In this case, thickness may be defined by how much space the cuff takes up on the length of the wearer's arm.

Another feature, in embodiments, may include a dry erasable ring with super fine tip marker on a necklace. These rings would allow for a writeable surface on the top of a sizeable ring. Similar small products may be adjusted to create dry-erase earrings with small draw-able surfaces that dangle from the ears.

Bracelet markers may be bendable and also snap around your wrist to act as a “bangle” and can be worn with the bracelet or on the opposite wrist. These markers can be built in any colors in order to look aesthetically pleasing to the wearer and may be worn with our original bracelet product.

Dry-erase anklets may also be made by making alterations in size and material to our bracelet product to allow a user to wear on their ankle

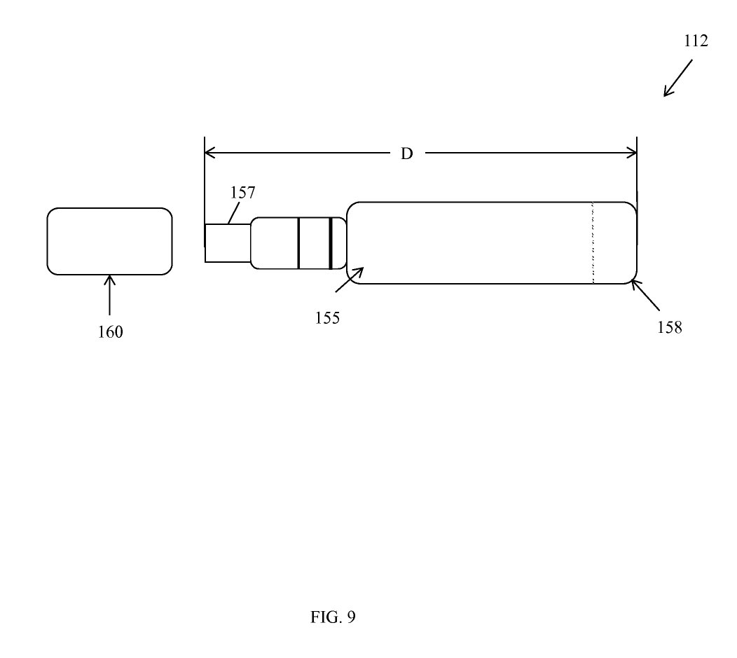

FIG. 9 is a set of illustrations of an example dry erase pen usable with the dry erase bracelet of FIG. 1, configured according to principles of the disclosure. The dry erase pen 112 (or 110) may be configured with a main body 155 including an ink writing end 157. An optional cover 160 may be employed to snap on to enclose the ink writing end 157 with the main body 155. In some applications, an eraser end 158 may be configured as part of the main body 155 which may be used to erase makings form the erasable surfaces of the bracelet 100. The length D of the marker may be about 2.057″, but may vary. In some embodiments the length D may be about 1.3″ or 0.875″. In some applications, the length D may be selected from a range from about 0.7″ to about 2.2″. Alternatively, a stand-alone eraser tool, similar in shape and size to the markers 110, 112 may be constructed to fit in a curl 115a, 115b. Such a tool may have one or more ends with an eraser surface.

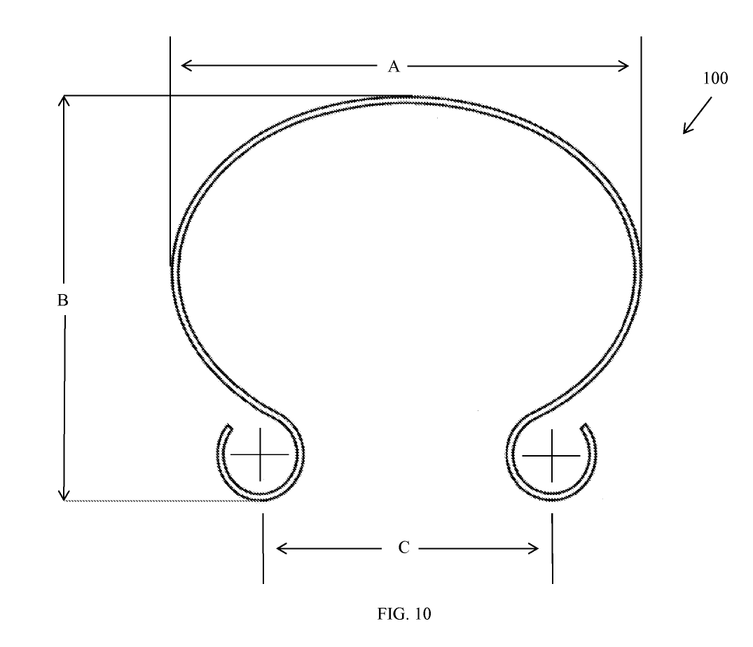

FIG. 10 is a set of illustrations showing exemplary dimensions of the bracelet 100 of FIG. 1. The width A may be selected from a range from about 2.1″ to about 3″. The width may be about 2.28″. The height B may be selected from a range of about 1.8″ to about 2″. In some embodiments the height B may be about 1.9″. The distance C, as measured between the centers of the curls 115a, 115b may be about 1.44″. The distance C may vary. In one aspect, the distance C may be selected from the range ranging from about 1.2″ to about 1.7″. Dimensions A, B and C may vary in different applications, such as, e.g., adults versus children.

### Exemplary Marker Details

Each bracelet 100 may be packaged with one or two markers, e.g., a color marker 110 and an eraser marker 112. Markers may be standardly thinner at the point and thicker on the opposite end to provide a snug fit into our bracelet holsters. These markers are typically small—about 0.320 inches in diameter, but can vary as other designs are created.

While the invention has been described in terms of examples, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

I claim:

1. A bracelet comprising:
a main body configured with a curved writeable outer surface and a curved inner surface;
a pair of spaced apart descending portions descending from the main body, wherein the descending portions narrow in width;
a pair of spaced-part curls formed on a lower end of the descending portions, wherein a width of each curl is less than the width of the main body, and
wherein each curl is configured to accept and hold a marker pen therewithin.

2. The bracelet of claim 1, wherein the writeable outer surface comprises a coating of material suitable for receiving and maintaining ink wherein the coating permits easy erasing of the ink.

3. The bracelet of claim 1, wherein the curved inner surface comprises a coating of material suitable for receiving and maintaining ink wherein the coating permits easy erasing of the ink.

4. The bracelet of claim 1, wherein each curl curls back toward the respective descending portion.

5. The bracelet of claim 1, wherein each curl is configured to be spaced-apart from one another so that the centers of each curl are configured to be at a distance selected from a range ranging from about 1.2″ to about 1.7″.

6. The bracelet of claim 5, wherein the distance is about 1.9″.

7. The bracelet of claim 1, wherein the bracelet is configured so that the curved outer surface becomes an inner surface of each curl.

8. The bracelet of claim 7, wherein the bracelet is configured so that the curved inner surface becomes an outer surface of each curl.

9. The bracelet of claim 1, further comprising at least one marker for producing erasable ink on at least one of the surfaces and configured to be insertable and removable within at least one curl and held therein by friction fit.

10. A bracelet comprising:
a main body configured with a curved writeable outer surface and a curved inner surface;
a pair of spaced apart descending portions descending from the main body, wherein the descending portions narrow in width;
a pair of spaced-part curls formed from a lower end of the descending portions, wherein a width of an outer surface of each curl is less than the width of the main body, and a distance from an outermost surface of one curl to an outermost surface of the other curl is less than the maximum overall width of the main body,
wherein each curl is configured to accept and hold a dry-erase marker pen therewithin.

11. The bracelet of claim 10, wherein the writeable outer surface comprises a coating of material suitable for receiving and maintaining ink wherein the coating permits easy erasing of the ink.

12. The bracelet of claim 10, wherein the curved inner surface comprises a coating of material suitable for receiving and maintaining ink wherein the coating permits easy erasing of the ink.

13. The bracelet of claim 10, wherein each curl curls back toward the respective descending portion and is one of: open and closed, with the descending portion.

14. The bracelet of claim 10, wherein each curl is configured to be spaced-apart from one another so that the centers of each curl are configured to be at a distance selected from a range ranging from about 1.2″ to about 1.7″.

15. The bracelet of claim 10, wherein the bracelet is configured so that the curved outer surface becomes an inner surface of each curl and the curved inner surface becomes an outer surface of each curl.

16. The bracelet of claim 10, further comprising at least one marker for producing erasable ink on at least one of the surfaces and configured to be insertable and removable within at least one curl and held therein by friction fit.

17. A method for making a dry erase bracelet, comprising the steps of:
providing a main body configured with a curved writeable outer surface and a curved inner surface;
configuring a pair of spaced apart descending portions descending from the main body, wherein the descending portions narrow in width;
forming a pair of spaced-part curls formed on a lower end of the descending portions, wherein a width of each curl is less than the width of the main body, and
wherein each curl is configured to accept and hold a marker pen therewithin.

18. The method of claim 17, wherein the writeable outer surface comprises a coating of material suitable for receiving and maintaining ink wherein the coating permits easy erasing of the ink.

19. The method of claim 17, wherein the curved inner surface comprises a coating of material suitable for receiving and maintaining ink wherein the coating permits easy erasing of the ink.

20. The method of claim 17, further comprising the step of providing a dry erasable ink marker configured to be held in at least one curl by friction fit.
